(19) United States
(12) Patent Application Publication
(10) Pub. No.: US 2020/0086786 A1
(43) Pub. Date: Mar. 19, 2020

(54) EXTERIOR ILLUMINATION SYSTEM FOR VEHICLE

(71) Applicant: MACBOX I, INC., Amityville, NY (US)

(72) Inventors: John J. Mackey, Amityville, NY (US); Jeffrey L. Bass, Plainview, NY (US); Randall Guensler, Atlanta, GA (US)

(21) Appl. No.: 16/563,354

(22) Filed: Sep. 6, 2019

Related U.S. Application Data
(60) Provisional application No. 62/727,714, filed on Sep. 6, 2018.

(51) Int. Cl. B60Q 9/00; B60Q 1/52

(52) U.S. Cl. CPC B60Q 9/00; B60Q 2400/00; B60Q 1/52

(57) ABSTRACT

An illumination system for a vehicle includes an illumination device securable to the vehicle and configured to provide illumination of the exterior of the vehicle and a surrounding environment in response to a signal; at least one lighting array in communication with the illumination device configured to illuminate the exterior of the vehicle and the surrounding environment based on the signal received by the illumination device; and a lift system coupled to the illumination device and configured to enable vertical, lateral, and rotational movement of the illumination device relative to the vehicle.

### FIELD

The present disclosure is generally related to the field of vehicles, and more particularly to a vehicle with exterior illumination system.

### BACKGROUND

Various devices have been implemented into vehicles to provide safety and prevent against theft. Such devices include electronic alarms, ignition-defeat systems, steering wheel locks, on-board safety monitors, GPS tracking, and other devices used to either prevent theft or assist in tracking of stolen vehicles.

### SUMMARY

Provided in accordance with the disclosure is an illumination system for a vehicle including an illumination device securable to the vehicle, at least one lighting array in communication with the illumination device, and a lift system coupled to the illumination device. The illumination device is configured to provide illumination of the exterior of the vehicle and a surrounding environment in response to a signal. The at least one lighting array is configured to illuminate the exterior of the vehicle and the surrounding environment based the signal received by the illumination device. The lift system is configured to enable vertical, lateral, and rotational movement of the illumination device relative to the vehicle.

In aspects, the illumination device may further include a light source coupled to a top of the illumination device.

In aspects, the light source may be a white light, a multi-color light, a multi-spectral light, or a non-visible spectra light.

In aspects, the at least one lighting array further includes at least one light and at least one reflector panel.

In aspects, each of the at least one lighting array may be a white light, a multi-color light, a multi-spectral light, or a non-visible spectra light.

In aspects, the illumination device may further include a communication protocol configured to communicate with a controller of the illumination device.

In aspects, the controller may be further configured to illuminate the illumination device and the at least one lighting array independently or together based on the signal.

In aspects, the signal may be a triggered security event or command received by the controller.

In aspects, the triggered security event may be one of at least operator or vehicle tampering, vehicle theft, or accident

In aspects, the illumination device may further include one or more sensors configured to detect the triggered security event.

In aspects, in response to the triggered security event, the controller may illuminate the illumination device and the at least one lighting array independently or together based on the signal.

In aspects, the illumination device may further include an audible alarm.

In aspects, the communication protocol may be further configured to support vehicle-to-vehicle communication and the controller communicates across multiple vehicles to provide collaborative illumination.

In aspects, the illumination device may further include a power source.

In aspects, the power source may be one of at least a battery, a solar cell, a fossil fuel generator, and a fuel cell power.

In aspects, the battery may be a battery that powers the vehicle.

In aspects, the illumination device and lighting array may be further configured to provide flashing patterns or text messages.

In aspects, the illumination device and lighting array may further include a protective layers configured to ruggedize the system.

In aspects, the controller is may be further configured to control angulation of the reflector panels, color of the light, a timer, and light brightness.

In aspects, the controller is may be further configured to control the an angle and an orientation of the light source, a color of the light source, a timer, and a brightness of the light source.

### BRIEF DESCRIPTION OF DRAWINGS

The accompanying drawings, which are incorporated in and constitute a part of this specification, illustrate embodiments of the disclosure and, together with the detailed description of the embodiments given below, serve to explain the principles of the disclosure.

FIG. 1 is a side view that illustrates a illumination system according to an embodiment of the disclosure including a lighting array and an illumination device with the illumination device depicted in the retracted position;

FIG. 2 is side view of the illumination system of FIG. 1 depicted with the illumination device in the extended position;

FIG. 3 is a front view illustrating the illumination device of FIG. 1 on a single vehicle;

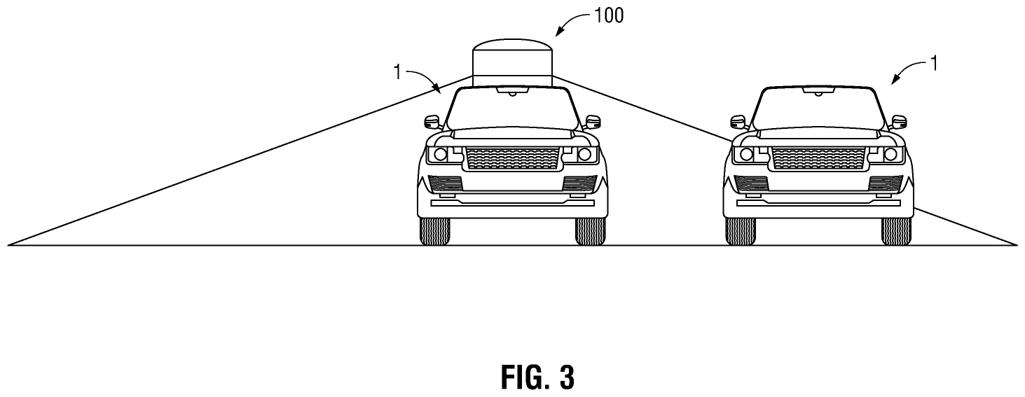

and

FIG. 4 is a front view illustrating the illumination device of FIG. 1 on multiple vehicles.

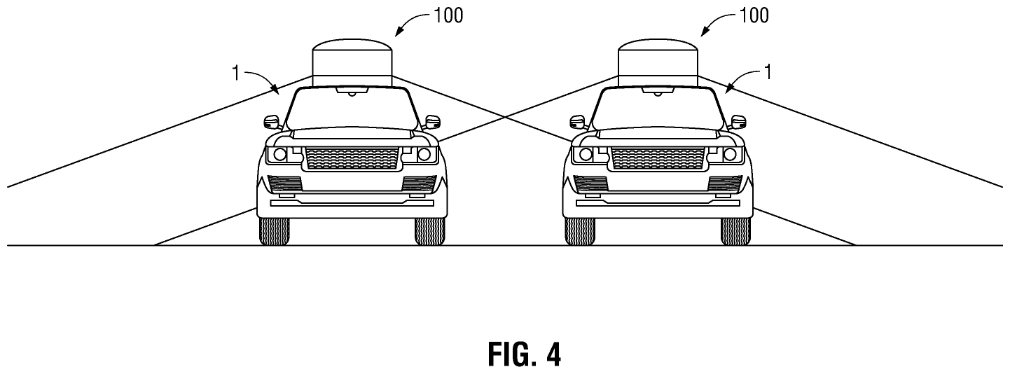

### DETAILED DESCRIPTION

Particular embodiments of the disclosure are described hereinbelow with reference to the accompanying drawings. In the following description, well-known functions or constructions are not described in detail to avoid obscuring the disclosure in unnecessary detail. As used herein, the term “vehicle” refers to any form of transportation. The illumination system provided herein includes features that provide exterior illumination of a vehicle for safety, security, and loss prevention. The system of the disclosure detailed below may be incorporated in different types of vehicles. The particular illustrations and embodiments disclosed herein are merely exemplary and do not limit the scope or applicability of the disclosed technology.

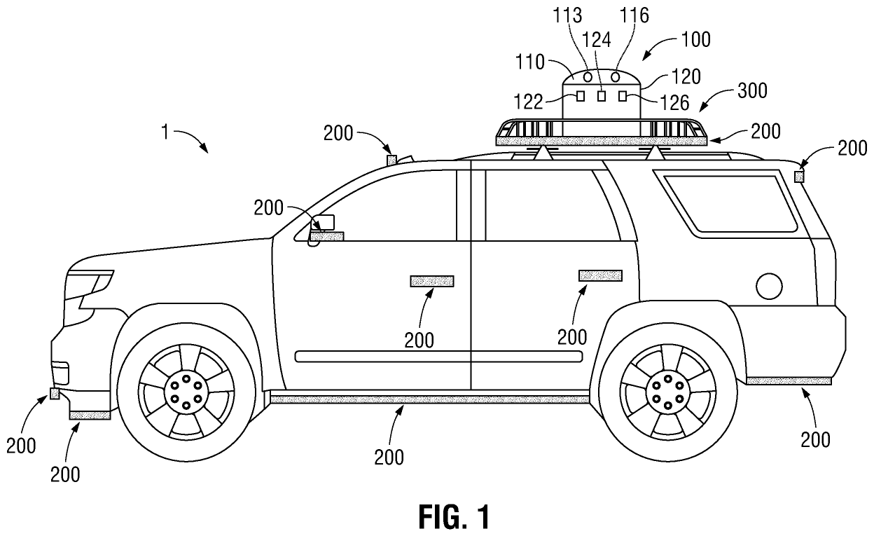

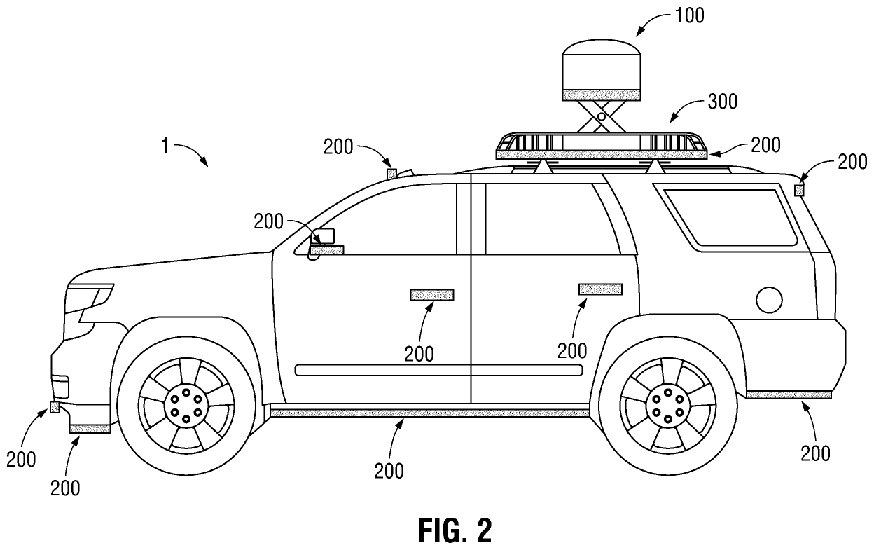

Referring initially to FIGS. 1 and 2, and embodiment of a vehicle 1, such as, for example, a sports utility vehicle, generally includes an illumination device 100, lighting arrays 200, and a lift system 300.

The lighting arrays 200 generally include at least one light, and at least one reflector panel. In some embodiments, the lighting arrays 200 may further include sensors. The light is configured illuminate in various colors, such as, for example, “Amber Alert” colors, white light, a multi-color light, a multi-spectral light, or a non-visible spectra light, or any other color contemplated for security and tracking purposes. The reflector panel is configured to reflect light beams downward and outward to illuminate the environment around the vehicle 1. In some embodiments, the reflector panel can be configured for angular rotation to adjust the downward and outward light angle. In some embodiments, the lighting arrays 200 may be coupled to various locations of the vehicle 1, such as, for example, affixed to any component of the vehicle (roof rack, interior window, roof frame, door frames, door handles, mirrors, etc., or in any manner desired so as not to be obtrusive). Additionally or alternatively, the lighting arrays 200 may be directly integrated, by the vehicle manufacturers, into vehicle panels or components. In some embodiments, existing lights and sensors of the vehicle may be used as lighting arrays.

The illumination device 100 is coupled to the roof of the vehicle 1 via the lift system 300 and configured to reduce aerodynamic drag in the retracted position (FIG. 1) and provide movement of the illumination device 100 vertically, laterally and/or rotationally relative to the vehicle 1, which may improve operation of the illumination device 100 (FIG. 2). The vertical height of the lift system 300 may be configured vary in height according to the type of vehicle 1 (e.g., vehicle as defined above including SUV, or low riding vehicle such as a Corvette, etc.). The lift system 300 is further configured to retract when the vehicle 1 is in motion. In other embodiments, the lift system 300 may include additional lighting arrays 200 disposed along an outer perimeter of the lift system 300 (FIG. 2).

The illumination device 100 generally includes a top portion 110 and a body 120. The body 120 of the illumination device 100 and the lift system 300 may be configured to conform to a desired shape, such as, for example, a dome, tetrahedron, or cylinder. The top portion 110 of the illumination device 100 configured to operate as a light source to provide 360 degrees of lighting with a diameter not less than 25 feet from the light source. In other embodiments, the top portion 110 of the illumination device 100 may further include a projector 113 and an image capturer device 116. The projector 113 is configured to project information onto adjacent surfaces. The image capturer device 116 is configured to monitor interior and exterior views of the illuminated environment.

Additional lighting arrays 200 may be disposed at various locations around an outer perimeter of the body 120 of the illumination device 100. The body 120 includes a communication transceiver 122, a controller 124, and a sensor array 126. In some embodiments, the communication transceiver 122, controller 124, and sensor array can be disposed anywhere on the illumination device or anywhere within or on the vehicle 1. The sensor array 126 generally includes a GPS sensor, accelerometers, gyroscopes, video sensors, sound sensors, vibration sensors, light sensors, and any other relevant sensors for tracking and security purposes.

The communication transceiver 122 is configured to send and receive encrypted signals and instructions to and from a communication protocol, such as, for example, a smartphone or any device/software capable of sending and receiving signals or managing settings. The communication transceiver 122 can receive signals and instructions from the communication protocol via cellular (voice and/or data), Wi-Fi, WLAN, Bluetooth, RFID, NFC, or other types of wireless communication. In other embodiments, the communication transceiver 122 can be a telematics system. The communication transceiver 122 may be further configured to support bi-directional data transmission vehicle-to-roadway (e.g., via a server connection) and vehicle-to-vehicle with other similarly-equipped vehicles, thereby allowing for multiple vehicles to work in tandem to provide additional lighting when desired, such as, for example in the event of a power outage. The controller 124 is coupled to the communication transceiver 122 and configured to execute instructions stored on memory according to the received signals, which may be based on stored (on memory) instructions from the communication protocol.

The controller 124 may activate the light source of the illumination device 100 and/or the illumination array when the vehicle 1 is parked to light up the surrounding environments, such as, for example parking garages, night-time sporting events, camping areas, and other activities requiring additional lighting. In some embodiments, the controller 124 sets a time or duration to deploy the illumination device 100, or illuminate the surrounding area. The controller 124 may receive a signal or instructions from the communication protocol to adjust the illumination device 100 to improve sensor coverage or extend lighting coverage of the light source by activating the lift system to adjust the vertical height, lateral placement, or rotation position of the illumination device 100. The controller 124 may further receive a signal or instruction from the communication protocol to adjust collectively, or individually the brightness, angle, and orientation of the light source, and each lighting and/or reflector panel within the lighting arrays 200 to improve lighting coverage.

The controller 124 is configured to monitor and interpret changes in the surrounding environment based on changes in the video and/or images obtained by the image capturer device 116 to detect approaching persons, vehicles, or other potential security threats.

The controller 124 is configured to detect when the vehicle 1 is in motion, and deactivate the light source and the various lighting arrays 200, and/or retract the lift system 300. To detect that the vehicle 1 is in motion, the controller 124 receives signals from the sensor array 126, for example, the GPS, gyroscope, accelerometer, and other sensors, to assess whether the vehicle 1 is in motion.

The controller 124 may further receive a signal or instructions from the communication protocol, sensor array 126, or other vehicles equipped with illumination device 100, indicating that there is an emergency circumstance, such as, for example, accident, tampering, theft, and/or distress of vehicle 1 or the operator. The controller 124 may illuminate the light source of the illumination device 100 and the various lighting arrays 200 in any color or prescribed pattern necessary to adequately alert, the vehicle operator, other vehicle operators, and/or law enforcement of the emergency circumstance. Additionally or alternatively, the controller 124 may include providing audible alarms.

For example, in the event, a theft of the vehicle 1 has occurred, the controller 124 receives the signal indicating that the vehicle 1 is stolen, and retrieves the location of the stolen or compromised vehicle 1, even while in motion. For example, in the event, distress is detected, the controller 124 receives the signal indicating that the vehicle 1 or the operator is in distress, and illuminate the light source of the illumination device 100 and the various lighting arrays 200 in “Amber Alert” colors, flashing patterns, and scrolling messages on the arrays to alert other drivers and/or law enforcement of the operator or vehicle's distress status. In some embodiments, the sensor array 126, may detect, for example an accident, in which a distress signal is sent to the communication transceiver 122 without communication from the communication protocol. In some embodiments, for example, distress is detected from a nearby vehicle, in which the controller 124 of vehicle 1 may receive a signal from the nearby vehicle to illuminate the light source of the illumination device 100 and the various lighting arrays 200, creating a crowd-sourced visual and audible alarm support for the nearby vehicle.

In some embodiments, in illuminating the light source of the illumination device 100 and the various lighting arrays 200 in any color or prescribed pattern necessary to adequately alert, the vehicle operator, other vehicle operators, and/or law enforcement of the emergency circumstance, the controller 124 send a signal to the communication transceiver 122 to communicate with the illumination device 100 of other vehicles to provide additional alerts, across the other illumination devices 100, including designation of colors, flashing patterns, text messages, thereby providing first-responders assistance in locating and administering assistance to those who may require assistance by indicating direction of the vehicle who may require assistance.

In some embodiments, the body 120 of the illumination device 100 may further include a power source, (e.g., batteries, solar cells, fossil fuel generator, or fuel cell power) configured to provide power to the communication transceiver 122, controller 124, sensor array 126, and other components of the illumination device 100. Additionally or alternatively, power may be drawn from other power sources available on or external to the vehicle.

In some embodiments, the illumination device 100, the lighting arrays 200, and the lift system 300 and any other related components may, may be configured to include a protective layers to ruggedize the system from tampering and the elements. The protective layer may include component isolation, or protection with layers of synthetic fibers, polyurethane, etc.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

While several embodiments of the disclosure have been shown in the drawings, it is not intended that the disclosure be limited thereto, as it is intended that the disclosure be as broad in scope as the art will allow and that the specification be read likewise. It is to be understood, therefore, that this disclosure is not limited to the precise embodiments described, and that various other changes and modifications may be effected by one skilled in the art without departing from the scope or spirit of the disclosure. Additionally, the elements and features shown and described in connection with certain embodiments may be combined with the elements and features of certain other embodiments without departing from the scope of this disclosure, and that such modifications and variation are also included within the scope of this disclosure. Therefore, the above description should not be construed as limiting, but merely as exemplifications of preferred embodiments. Thus the scope of the embodiments should be determined by the appended claims and their legal equivalents, rather than by the examples given.

What is claimed is:

1. An illumination system for a vehicle comprising:
an illumination device securable to the vehicle and configured to provide illumination of an exterior of the vehicle and a surrounding environment in response to a signal;
at least one lighting array in communication with the illumination device, wherein the at least one lighting array is configured to illuminate the exterior of the vehicle and the surrounding environment based on the signal received by the illumination device; and
a lift system coupled to the illumination device and configured to enable vertical, lateral, and rotational movement of the illumination device relative to the vehicle.

2. The illumination system according to claim 1, wherein the illumination device further includes a light source coupled to a top of the illumination device.

3. The illumination system according to claim 2, wherein the light source is selected from the group consisting of a white light, a multi-color light, a multi-spectral light, and a non-visible spectra light.

4. The illumination system according to claim 1, wherein the at least one lighting array further includes at least one light and at least one reflector panel.

5. The illumination system according to claim 4, wherein each of the at least one lighting array is a selected from the group consisting of a white light, a multi-color light, a multi-spectral light, and a non-visible spectra light.

6. The illumination system according to claim 1, wherein the illumination device further includes a communication protocol configured to communicate with a controller of the illumination device.

7. The illumination system according to claim 6, wherein the controller is further configured to illuminate the illumination device and the at least one lighting array independently or together based on the signal.

8. The illumination system according to claim 1, wherein the signal is a triggered security event or command received by the controller.

9. The illumination system according to claim 8, wherein the triggered security event is selected from the group consisting of operator distress, vehicle tampering, vehicle theft, and accident.

10. The illumination system according to claim 8, wherein the illumination device further includes one or more sensors configured to detect the triggered security event.

11. The illumination system according to claim 8, wherein in response to the triggered security event, the controller illuminates the illumination device and the at least one lighting array independently or together based on the signal.

12. The illumination system according to claim 1, wherein the illumination device further includes an audible alarm.

13. The illumination system according to claim 6, wherein the communication protocol is further configured to support vehicle-to-vehicle communication,
wherein the controller communicates across multiple vehicles to provide collaborative illumination.

14. The illumination system according to claim 1, wherein the illumination device further includes a power source.

15. The illumination system according to claim 14, wherein the power source is selected from the group consisting of a battery, a solar cell, a fossil fuel generator, and a fuel cell power.

16. The illumination system according to claim 15, wherein the battery is a battery that powers the vehicle.

17. The illumination system according to claim 1, wherein the illumination device and the at least one lighting array is further configured to provide flashing patterns or text messages.

18. The illumination system according to claim 1, wherein the illumination device and the at least one lighting array further include a protective layer configured to ruggedize the system.

19. The illumination system according to claim 5, wherein the controller is further configured to control angulation of the reflector panels, color of the light, a timer, and light brightness.

20. The illumination system according to claim 3, wherein the controller is further configured to control an angle and an orientation of the light source, a color of the light source, a timer, and a brightness of the light source.
